(19) United States
(12) Patent Application Publication
(10) Pub. No.: US 2003/0031996 A1
(43) Pub. Date: Feb. 13, 2003

(54) Method and system for evaluating documents

(76) Inventor: Adam Robinson, New York, NY (US)

Correspondence Address: PENNIE & EDMONDS LLP, 1667 K STREET NW, SUITE 1000, WASHINGTON, DC, 20006

(21) Appl. No.: 09/923,334

(22) Filed: Aug. 8, 2001

(51) Int. Cl. G09B 3/00

(52) U.S. Cl. 434/350

(57) ABSTRACT

A system and method for evaluating documents is disclosed. In a preferred embodiment, a system and method for grading essays in an actual examination, or for submission and grading of essays in a practice mode is facilitated by a computer. The essay grading system receives submissions of essays concerning an essay topic, compares a submitted essay with an ideal essay concerning the same essay topic, scores the submitted essay, and comments on how to improve over the submitted essay. When commenting, the essay grading system lists a set of key terms that are contained in the ideal essay, with an indication whether each of these terms is contained in the submitted essay.

### FIELD OF THE INVENTION

The present invention relates to methods and systems for evaluation of documents such as written responses. More specifically, the present invention relates to a method and system for on-line electronic grading of essays in response to examination questions.

### BACKGROUND OF THE INVENTION

The notion of automated essay grading has been in existence for decades, since the 1960's when mainframes were in use. Generally, a computerized essay grading system relies on “proxies” for writing ability that correlate with previously graded essays. For example, for a given essay question, an evaluator would grade a number of responsive essays and the software would then analyze the correlation between the grade the evaluator gave to an essay and the structure of the essay, such as the number of paragraphs and the average word length. Ponderous mathematical algorithms would be employed to establish formulae that would be applied to ungraded essays.

Computerized essay grading has become a trend in standardizing essay examination administration. For example, U.S. Pat. No. 5,180,309 discloses an automated answer evaluation and scoring system and method for achieving automated evaluation and scoring of a participant's response to questions selected pseudo-randomly. A plurality of questions are available for each of a plurality of categories, in a question file.

Also, systems employing human readers have been developed to retain consistency and accuracy in essay grading. For example, U.S. Pat. No. 5,987,302 discloses an on-line essay evaluation system offering students the opportunity to prepare practice essays and to submit the essays to trained, expert readers, and to retrieve an evaluation at the student's convenience.

### SUMMARY OF THE INVENTION

The present invention is directed to a computer-assisted method of evaluating an essay. The computer-assisted method comprises receiving an essay concerning an essay topic; electronically comparing textual content of the essay with a first number of terms related to the essay topic; identifying missing terms among the first number, the missed terms being those terms which are not present in the textual content of the essay; and transmitting the missed terms.

The computer-assisted method may further comprise transmitting at least one essay score along with the identified terms. It may also further comprise transmitting at least one essay subscore along with the identified terms and the essay score. In addition, it may further comprise identifying and transmitting terms among the first number which are present in the textual content of the essay.

The present invention is directed to a computer storage medium having executable software code stored thereon. The executable software code includes code to receive an essay concerning an essay topic; code to electronically compare textual content of the essay with a first number of terms related to the essay topic; code to identify terms among the first number which are not present in the textual content of the essay; and code to transmit the identified terms.

The computer storage medium may further include code to identify and transmit terms among the first number which are present in the textual content of the essay. Also, it may further include code to generate and transmit a score concerning the essay. In addition, it may further include code to generate and transmit a subscore concerning the essay.

The present invention is directed to a computer-assisted method of evaluating an essay on an essay topic. The computer-assisted method comprises providing a first essay on the essay topic, wherein the first essay is a model essay; extracting a first set of terms found in the model essay; receiving a second essay on the essay topic; electronically searching through the second essay for terms within the first set; and transmitting those terms within the first set which are not present in the second essay.

The computer-assisted method may further comprise transmitting those terms within the first set which are present in the second essay. It may also further comprise providing and transmitting a score concerning the second essay. In addition, it may also further comprise providing and transmitting a subscore concerning the second essay.

The present invention is directed to a computer-assisted method of taking an essay examination. The computer-assisted method comprises drafting an essay about an essay topic; submitting the essay for evaluation by a computer; and receiving a first list of terms which are related to the essay topic, but were not included in the essay that was drafted and submitted for evaluation.

The computer-assisted method may further comprise receiving a second list of terms which are related to the essay topic and were included in the essay that was drafted and submitted for evaluation. It may also further comprise receiving a score concerning the essay in addition to the first list of terms. It may also further comprise receiving a subscore concerning the essay in addition to the first list of terms and the score. In addition, it may further comprise revising an existing essay which previously was submitted for evaluation.

The present invention is directed to a computer having associated therewith executable software code configured to grade an essay. The executable software code includes code to receive an essay concerning an essay topic; code to electronically compare textual content of the essay with a first number of terms related to the essay topic; code to identify terms among the first number which are not present in the textual content of the essay; and code to transmit the identified terms.

The executable software code may further include code to identify and transmit terms among the first number which are present in the textual content of the essay. Also, it may further include code to generate and transmit a score concerning the essay. In addition, it may further include code to generate and transmit a subscore concerning the essay.

The present invention is directed to a computer-assisted method of evaluating a document concerning at least one topic. The computer-assisted method comprises receiving a document from a first computer; electronically comparing textual content of the document with predetermined list comprising a first number of terms related to the at least one topic; identifying terms among the first number which are not present in the document; and transmitting the identified terms to the first computer.

### BRIEF DESCRIPTION OF THE DRAWINGS

The present invention is described in detail below with reference to the drawings in which:

FIG. 1 shows a block diagram of a grading system in accordance with the present invention;

FIG. 2 shows the process of interacting with an essay grading system in accordance with the present invention;

FIG. 3 shows a sample display related to 910 of FIG. 2;

FIG. 4 shows a sample display related to 912 of FIG. 2;

FIG. 5 shows another sample display related to 912 of FIG. 2;

FIG. 6 shows a sample display related to 916 of FIG. 2;

FIGS. 7a-c show another sample display related to 916 of FIG. 2;

FIG. 8 is a flow chart showing the method of the essay grading system according to the present invention;

FIG. 9 shows another sample display related to 916 of FIG. 2; and

FIG. 10 shows another sample display related to 916 of FIG. 2.

### DETAILED DESCRIPTION OF PREFERRED EMBODIMENTS

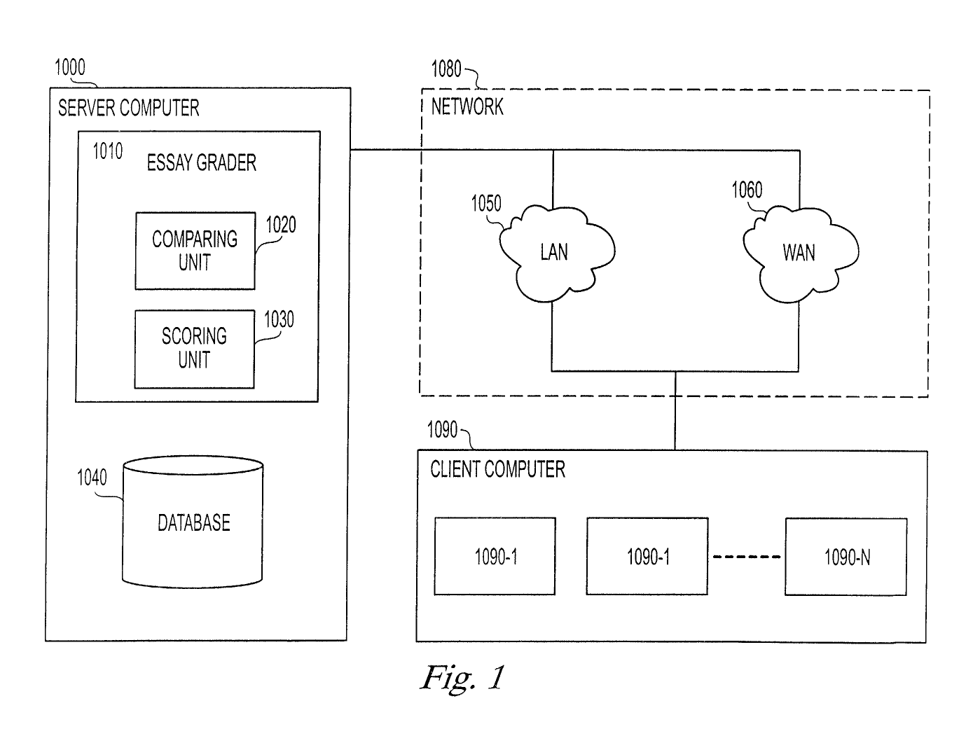

FIG. 1 shows a block diagram overview of one embodiment of the essay grading system according to the present invention. At least one server computer 1000 is connected to a network 1080, as is at least one client computer 1090. The network 1080 can be a local area network (LAN) 1050, such as a network consisting of a plurality of client computers 1090 at an examination facility, or a wide area network (WAN) 1060, such as the Internet.

In a preferred embodiment, the server computer 1000 and the client computer 1090 are separate computers and may be remotely connected. Alternatively, the server computer 1000 and the client computer 1090 can be the same computer. In such an embodiment, the same computer can possess the capabilities of the server computer 1000 and those of the client computer 1090. In such circumstances, there may be no need for a network.

The server computer 1000 can include a processor, a disk drive, and a memory such as a semiconductor memory, and runs an operating system such as Windows-NT or Linux. The server computer 1000 is additionally equipped with a data communications device such as a network card or gateway to connect to the network 1080. In a preferred embodiment, the server computer can also comprise an essay grader 1010, implemented in software, and a database 1040.

The database 1040 stores information using, for example, an Oracle Relational Database Management System. The information stored in such a database may be provided by the entity operating the server. The database, however, can also be used to store information sent from, and requests made by, the client computer. In a preferred embodiment, the database 1040 can store client information, including client registration data, requests submitted, results of essay submissions, and scores of submitted essays. The database 1040 also stores examination information, including essay questions and a set of key terms, or key words, that would be contained in an ideal, model essay associated with each essay question.

The set of key terms that would be contained in an ideal, model essay associated with an essay question or questions comes from analyses of text books. It may also come from consultation with professors and/or experts in the relevant field. Also, it may come from the statistics obtained from the results fed back from professors and/or experts in the relevant field in their “trial” examinations conducted prior to the release of the question to users in general. A set of key terms, along with the information concerning these terms, will be associated and designated, and therefore stored together in database 1040, with each essay question. The key terms are referred to as “ideal terms”. Variants of these terms, such as those formed using common prefixes, suffixes, tenses and the like, are either also entered, or are automatically generated on the fly during the analysis of an essay or other document. In addition, synonyms of these terms may also be stored, or used by means of an electronic thesaurus or the like.

In addition, studies can be conducted, prior to the release of a question, on how an essay evaluator would weigh the ideal terms and score a submitted essay based on the inclusion and omission of each term within the set of ideal terms. Similar studies can also be conducted on how an essay evaluator would grade a submitted essay in terms of a general, total score and in terms of subscores. The general, total score concerns the overall accomplishment of the submitted essay, such as the overall similarity between the ideal, model essay and a submitted essay. Each of the subscores concerns a specific aspect of the submitted essay. The specific aspects include the content, structure, style, argument, and specificity concerning a sub-subject. The total score and the subscores may also come from analyses of text books. They may also come from consultation with professors and/or experts in the relevant field. Also, they may come from the statistics obtained from the results fed back from professors and/or experts in the relevant field in their “trial” examinations conducted prior to the release of the question to users in general. One set of such evaluation information, including the weighting of the ideal terms and the scoring and subscoring based on the ideal, model essay, will be associated and designated, and therefore stored together in database 1040, with each essay question. This evaluation information is referred to as “expert information”.

The essay grader 1010 includes a comparing unit 1020 and a scoring unit 1030. The comparing unit 1020 comprises software that provides essay analysis functions, including receiving from a client computer 1090 submissions of an essay associated with a question and comparing the submitted essays with a set of ideal terms associated with the same question. In a preferred embodiment, the comparing unit 1020 includes software to identify the ideal terms that are missing in a submitted essay, based on the ideal terms and the associated and designated information stored in database 1040. The ideal terms that are missing in a submitted essay are referred to as “missed terms”.

Preferably, the comparing unit 1020 also includes software to identify the ideal terms that are present in a submitted essay. The ideal terms that are present in a submitted essay are referred to as “included terms”.

The scoring unit 1030 contains software which provides essay evaluation functions, including grading a submitted essay and sending reports back to the client computer 1090 concerning the submitted essay. In a preferred embodiment, the scoring unit 1030 includes software which performs the evaluation of a submitted essay based on the expert information stored in database 1040. Preferably, the scoring unit 1030 contains software which sends a list of missed terms back to the client computer 1090. Also preferably, the scoring unit 1030 contains software which sends back to the client computer 1090 a list of ideal terms, specifying whether each ideal term is a missed term or an included term. Such a list is referred to as “verbatim list”.

In general, the connection between the server computer 1000 and the network 1080 can be established in a manner known in the art. For example, the server computer 1000 can be connected to the Internet via an Internet Service Provider (ISP) or a direct connection. In a preferred embodiment, the server computer 1000 is connected to the Internet via a high-speed connection such as a Digital Subscriber Line or cable connection or a T1 connection, or the like, in order to receive and service numerous requests at a high data rate.

In addition, the server computer 1000 is preferably configured to function as a web server. The web server is typically a general purpose computer such as the server computer running software such as Common Gateway Interface (CGI) programs. The CGI programs provide for communication and interaction between a client computer 1090 and the server computer 1000 via the Internet. These CGI programs, coupled with data communications software programs, are configured to receive packets of messages from computers connected to the Internet, decipher the information in the packets, and act according to instructions provided in the packets within the constraints imposed by an administrator managing the server computer 1000. Commercial suppliers such as Netscape Corporation market web server software. Additionally, such web server software can also be downloaded and configured free of charge from other sources. Persons skilled in the art understand how to write CGI programs in programming languages such as UNIX Shell script, Perl, C, C++, Java, and others.

In addition to performing the tasks of receiving and sending packets of data to and from the computers connected to the Internet, the CGI programs are configured to perform other tasks such as communicating with the database 1040 of the server computer 1000, and extracting or storing information in the database according to the software instructions provided within the server computer 1000 or in the packets received from the Internet. The server computer 1000 is configured to receive request messages from client computer 1090 over the Internet in the Hyper Text Transfer Protocol (HTTP), File Transfer Protocol (FTP), or any similar protocol used to transfer data. After analyzing the request messages, the server computer 1000 is configured to transmit in response messages that include “web pages” that are programmed in Hyper Text Markup Language (HTML) or a similar language. Embedded in the web pages are components such as documents, scripts, objects, and frames that enable the server computer 1000 to display colorful graphical images on a display device coupled to the client computer 1090. Persons skilled in the art know how to make web pages using programming languages or tools such as HTML, Cold Fusion, Java, Java Script, Active Server Pages, Dynamic HTML, Extensible Markup Language (XML), etc.

The client computer 1090 is also connected to the network 1080. It may be connected to a local area network (LAN) 1050, such as a network consisting of a plurality of client computers 1090 at an examination facility, or a wide area network (WAN) 1060, such as the Internet. It may be connected to the Internet either directly, or via an Internet service provider, as is known to those skilled in that art. The client computer 1090 may also belong to a private network having a gateway connection to the Internet. In a preferred embodiment, a client computer 1090 illustratively comprises a microprocessor such as a Pentium III microprocessor, a magnetic, optical or other type of disk drive, a memory such as a semiconductor memory, a keyboard or other character input device, a mouse or other pointing device, and a display device such as a CRT or a flat panel display. In addition to operating system software, the client computer 1090 also executes a program called a web browser, or simply, a browser. The browser is a computer program that provides access to the vast resources of the Internet. Typically, this is done by providing a “window” to the data located on other computers connected to the Internet. Examples of browser programs available are Netscape Navigator, Opera, and Microsoft Internet Explorer.

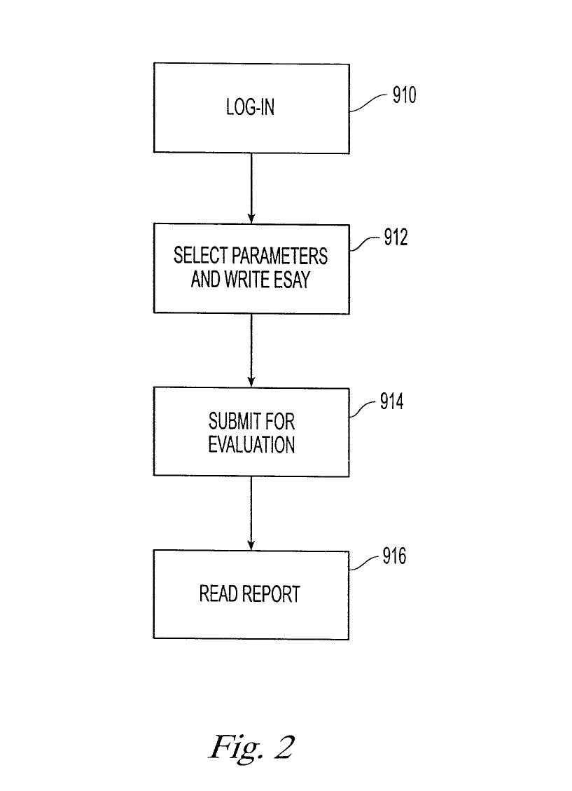

FIG. 2 is a flow chart showing the general process when using the essay grading system according to the present invention. As shown in FIG. 2, the user can log into the system at 910. At 912, the user can select essay parameters, which will be discussed in detail below, and writes an essay. At 914, the user submits the essay for evaluation. Finally, at 914, the user receives and reads the report on the submitted essay.

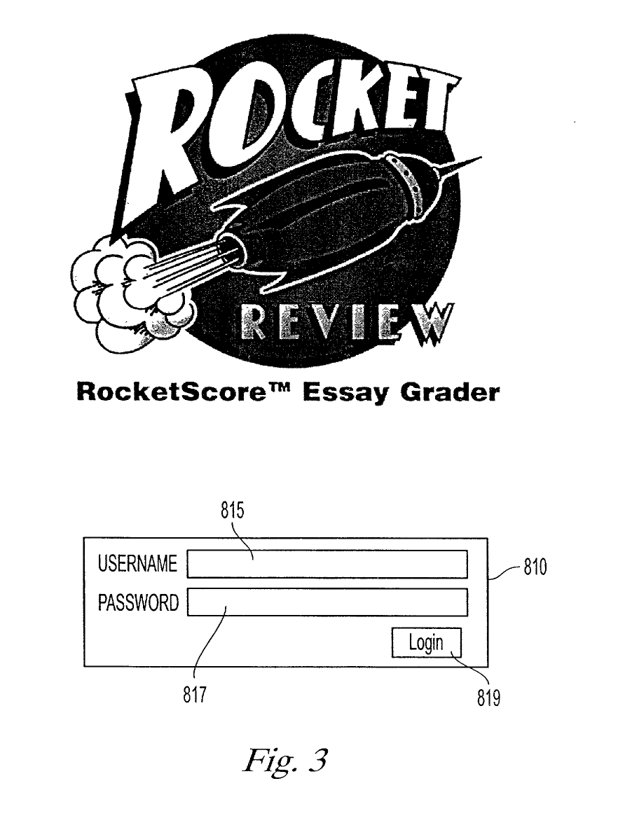

FIGS. 3-7 show sample displays of the user interface, preferably displayed at the user's browser, in a preferred embodiment of the essay grading system. The essay grading system operates in one of two modes: “practice” and “examination”. In practice mode, the user has a number of options, including the option of essay topic, time, and grading policy. The preferred embodiment shown in FIGS. 3-6 is described in practice mode. It is readily understood that, in examination mode, the number of options is limited.

FIG. 3 shows a sample display related to 910 of FIG. 2. In this sample, the essay grading system transmits a log-in page to the client computer. This page consists of a log-in panel 810 with a username field 815, a password field 817, and a login button 819. A user, authorized with a username and a password, logs into the essay grading system by entering the username in the username field 815, entering the password in the password field 817, and activating the login button 819.

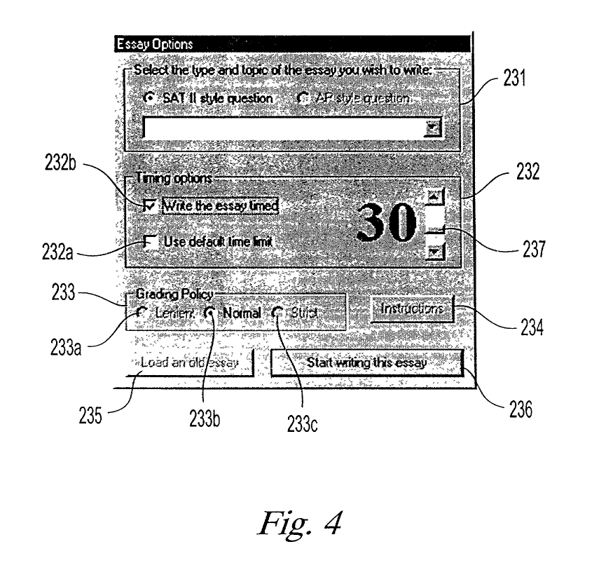

FIG. 4 shows a sample display related to 912 of FIG. 2. In this sample, the essay grading system transmits an “Essay Options” page to the client computer. This page includes 6 panels: an essay style and topic option panel 231, a timing option panel 232, a grading policy panel 233, an instruction panel 234, a “Load Old Essay” panel 235, and the start panel 236.

The essay style and topic option panel 231 allows an user to choose between an SAT II (Scholastic Aptitude Test II) style question and an AP (Advanced Placement) style question. Upon choosing a style of question, the user may choose an essay topic, which indicates the general area in which a specific essay question will appear for the user to write on. In other words, the user may choose only the general area the user wishes to write about without any control over the exact question the user is to write about. When the user selects an appropriate button on the display page of the essay grading system indicating an essay style, a list of essay topics is transmitted from the essay grading system server to the client computer, and the user may choose an essay topic from the list.

The timing option panel 232 provides two timing options to the user. The user can select the “Use default time limit” check box 232a and choose to have a default time, which is preferably 30 minutes. Alternatively, the user can select the “Write the essay timed” check box 232b and choose the amount of time the user wishes to spend, such as 30 minutes, 40 minutes, 60 minutes, and so forth. The user can increase or decrease the amount of time by sliding up or down a slidable scroll 237 in the timing option panel 232. The range of the amount of time is between one to 90 minutes and the increment for adjustment is one minute. The selected time is displayed in the page and the display of the time changes simultaneously as the time is adjusted by the sliding of the slidable scroll.

The grading policy panel 233 allows the user to choose among three radio buttons: lenient 233a, normal 233b, and strict 233c. These buttons represent three different grading policies. In the “normal” grading, the submitted essay will be graded against a criterion that is used in an actual examination. In the “lenient” grading, the criterion will be somewhat lowered and the essay will be graded with leniency. In the “strict” grading, the submitted essay will be graded against a higher standard.

The instruction button 234 gives the user the opportunity to obtain information concerning the essay grading system. It is similar to a user guide or user manual. A user can select on the “Instruction” button 234 for help if the user has a question about the essay grading system.

The “Load Old Essay” button 235 gives a user the option of reviewing an essay the user submitted earlier. By selecting on the “Load Old Essay” button, the user will be prompted for information concerning the old essay, such as the topic and the submission date. Upon receiving such information, the essay grading system will execute an appropriate software package to verify, from the information stored in the database, whether such an old essay exists. If the old essay exists, the essay grading system will display the old essay and the associated scores and report. That is, when the user selects an appropriate button on the display page of the essay grading system indicating the review of an essay submitted in an earlier essay session, the essay and the associated scores and report are transmitted from the essay grading system server to the client computer.

Upon a successful selection of essay parameters, the user may select the “Start Writing Essay” button 236 to cause the essay grading system to go to the next stage for the user to start the actual writing.

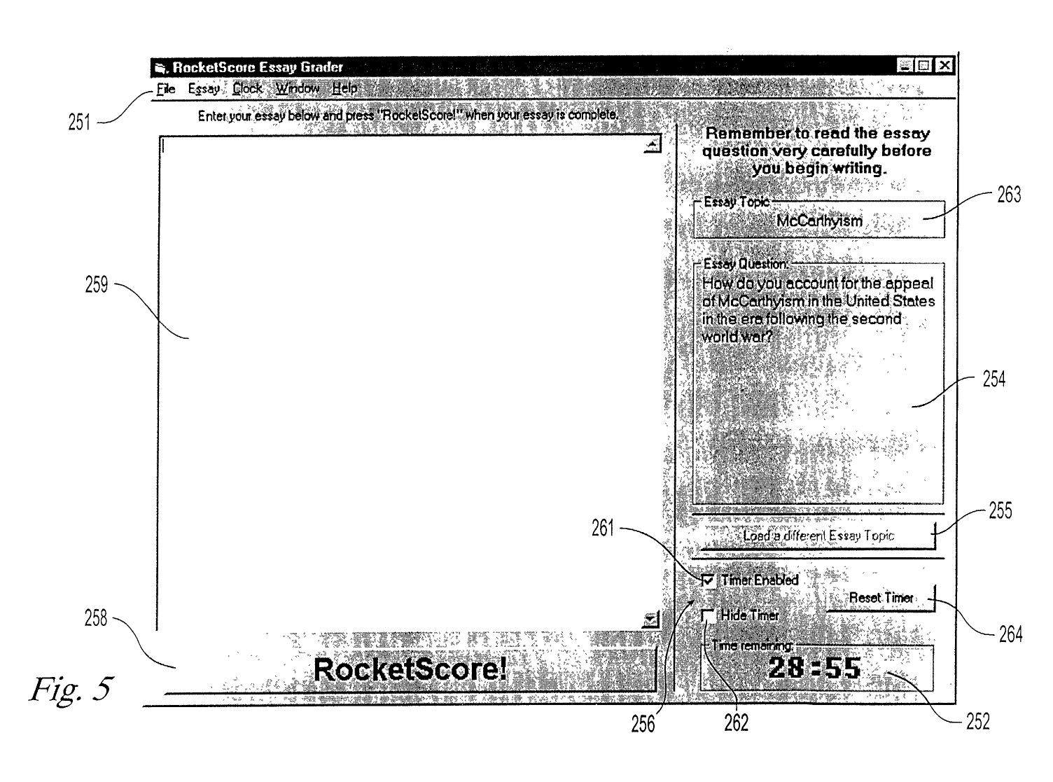

FIG. 5 shows another sample display related to 912 of FIG. 2. In this sample, the preferred embodiment of the essay grading system provides an essay input screen to the user at the client computer. This display contains 9 panels: an essay receiving panel 259, a status menu 251, a timer panel 252, an essay topic panel 263, an essay question panel 254, a “load a different essay topic” button 255, a timing option button 256, and a “RocketScore!” button 258 to submit the essay for grading.

The essay receiving panel 259 provides an editing window for the user to input and write an essay in accordance with the essay parameters chosen.

The status panel 251 consists of pull-down menus such as “file”, “essay”, “clock”, “help” and “debug”. These menus enable the user to adequately write in the editing window 259, with such editing capabilities as screen copying, pasting, and the like, similar to the user would have in a word processor such as WordPerfect and Microsoft Word.

The timer panel 252 comprises a clock showing the time remaining. While the user is writing the essay, the clock ticks away and the time remaining shown in the clock reduces preferably a second at a time. For example, if the user chooses the amount of time to be 30 minutes in the timing option panel 252 of FIG. 4, the time remaining shown in the clock will start as 30:00 and progressively reduce to 29:59, 29:58, . . . until the user finishes the writing and submits the essay by selecting on the “RocketScore” button 258 described below, or until the time remaining shown in the clock is reduced to 0:00, when the writing is automatically terminated and whatever has been input in the editing window is automatically submitted for grading. When the writing is submitted, whether voluntarily or involuntarily, it is transmitted to the essay grading system for evaluation and scoring.

The essay topic panel 263 reminds the user of the topic the user chose in the essay style and topic option panel 231 of FIG. 4. The essay question panel 254 contains the specific question the user is writing about. The question is prompted to the user after the user chooses an essay topic, which is an indication of the general area to which the specific essay question belongs.

The “load a different essay topic” button 255 gives a user the choice of changing to another essay topic in a practice session. In a preferred embodiment, a user, upon deciding that the current essay topic is not really of interest, may activate the “Load a different essay topic” button, whereupon the essay grading system will then loop back to the window shown in FIG. 4.

The timing option panel 256 includes the options of “timer enabled” 261, “hide timer” 262, and “reset timer” 264. The “timer enabled” check box 261 is useful when the user needs to be away for a period of time. Marking the check box 261 enables the clock and unmarking the check button disables the clock. When the clock is ticking down in panel 252 and when the user needs to leave the client computer for a while, the user may select the “timer enabled” check box 261 to disable the clock. The user can select the “timer enabled” check box 261 again, upon returning to the computer, to enable the clock.

The “hide timer” check box 262 allows the user to hide the clock in panel 252. By marking “hide timer” check box 262, the clock will disappear from panel 252 while the time will continue to tick away in the background. By unmarking this check box 262, the clock will reappear in panel 252.

The “reset timer” button 264 resets the clock shown in panel 252. It is used when the user needs to start the writing over again or when the user needs to adjust the amount of time for the writing. It is not available, however, in an examination session.

The “RocketScore!” button 258, when activated, submits the writing. After the user finishes writing, a user voluntarily submits the writing to the essay grading system by selecting the “RocketScore!” button 258. However, when time is up, the essay grading system automatically closes the input screen, even if the user has not finished writing, and transmits whatever is on the screen to the essay grading system for grading without the user's selecting the “RocketScore!” button 258.

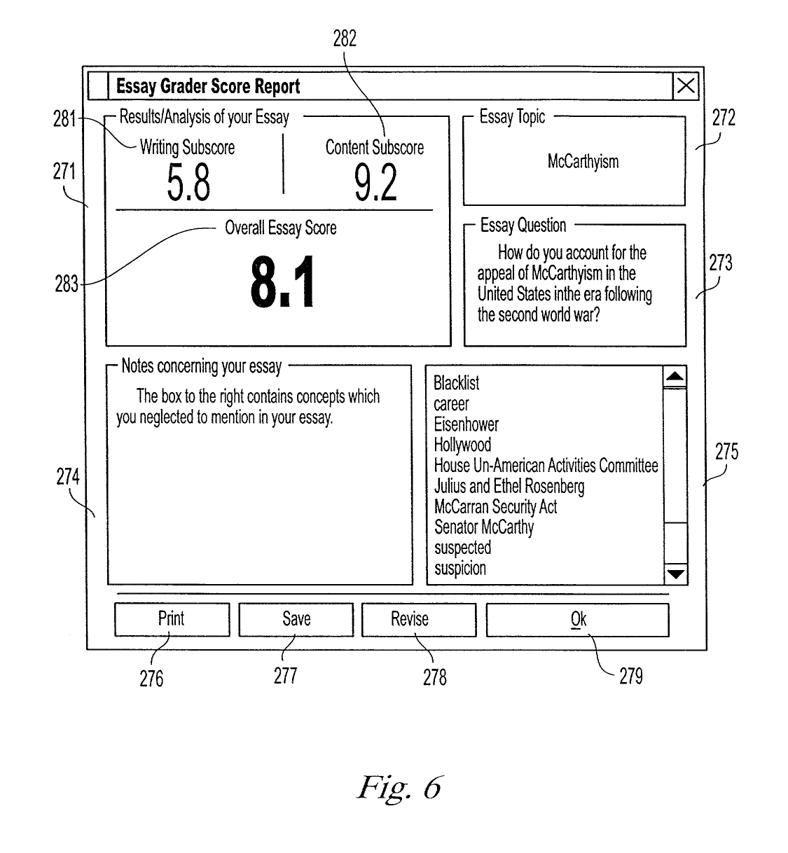

FIG. 6 shows a sample display related to 916 of FIG. 2. In this sample, the essay grading system transmits an “essay grader score report” page to the client computer. This display includes 9 sections: a score report panel 271, an essay topic panel 272, an essay question panel 273, a comment panel 274, a panel of missed terms 275, a print button 276, a save button 277, a revise button 278, and an “OK” button 279.

The score report panel 271 includes an overall essay score panel 283, a writing subscore panel 281, and content subscore panel 282. Overall essay score panel displays the overall score of the submitted writing. It is based on the analysis of the degree of similarity between the submitted writing and the ideal essay established from the analysis of textbooks. Content subscore panel 282 displays a score based on a similarity index indicating the similarity between the submitted writing and the ideal essay. It could be further broken down to “topic specific” content and “general” content. Writing subscore panel 281 displays a score based on how well the user's submission is written. It could be further broken down to “style” and “structure”.

The essay topic panel 272 recites the essay topic shown in the essay topic panel 263 of FIG. 5. The essay question 273 recites the essay question panel 254 of FIG. 5. The “note concerning your essay” panel 274 contains some general comments on the writing and the panel of missed terms 275 contains a list of missed terms.

The print button 276 allows the user to print out a hard copy of the essay grader score report shown in FIG. 6. The save button 277 permits the user to save the essay grader score report shown in FIG. 6 in, for example, a file. The revise button 278 allows the user to revise the submitted writing by taking the user back to the screen shown in FIG. 5 to edit the writing. This option, however, is not available in an examination session. The “OK” 279 allows the user to end the view of the screen of FIG. 6 and to proceed to the next screen display.

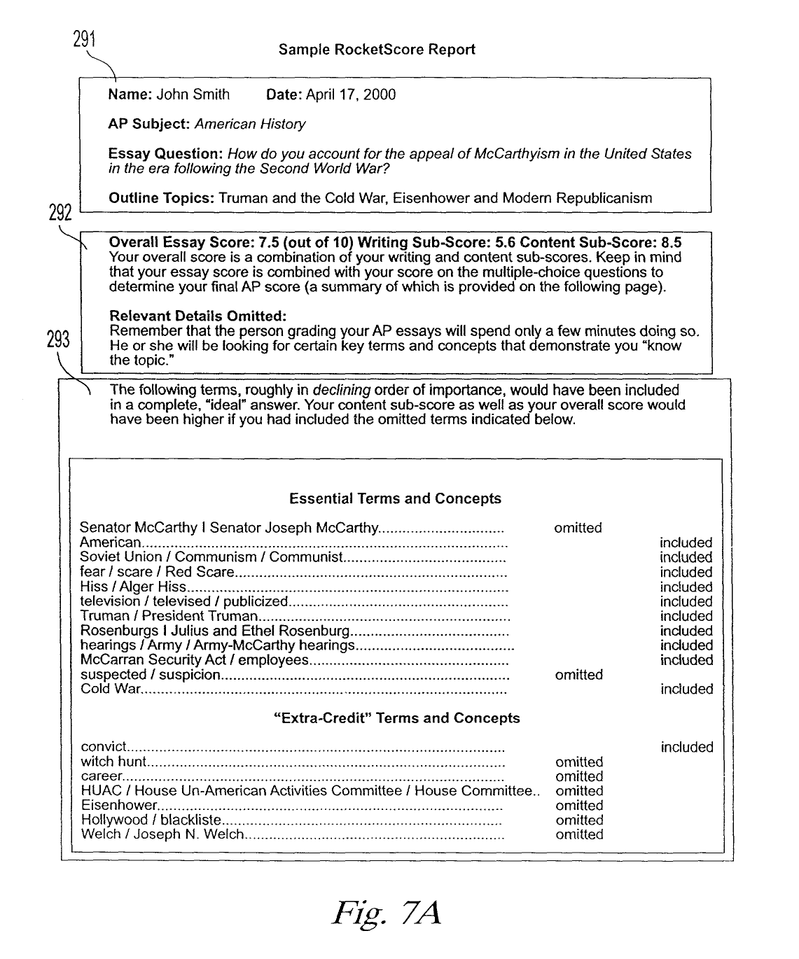

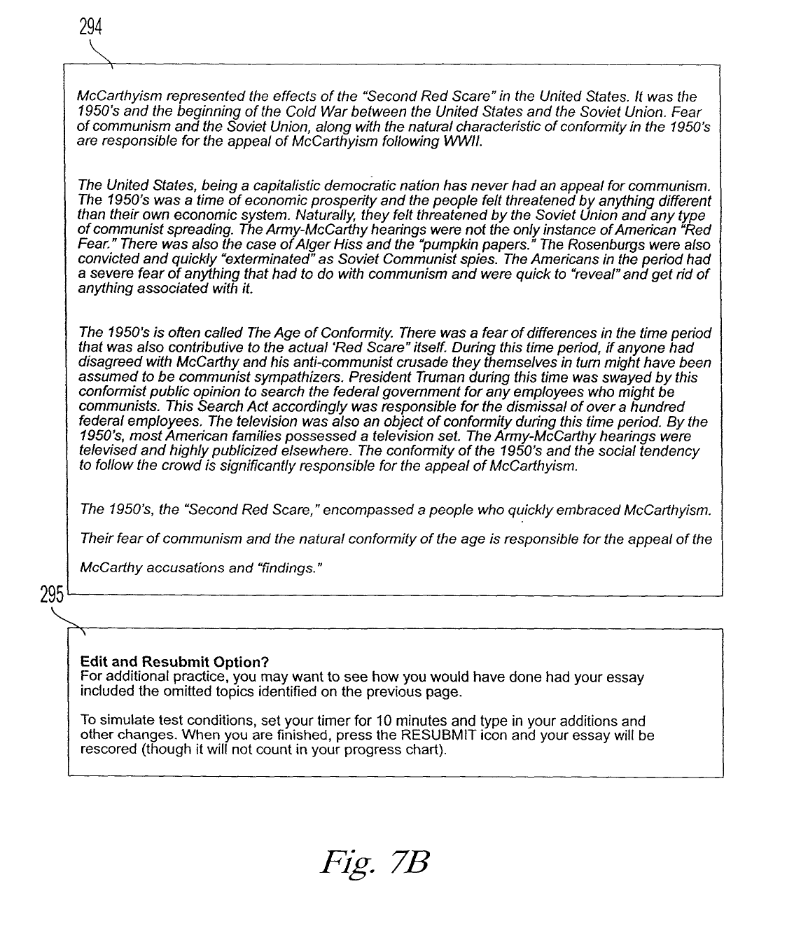

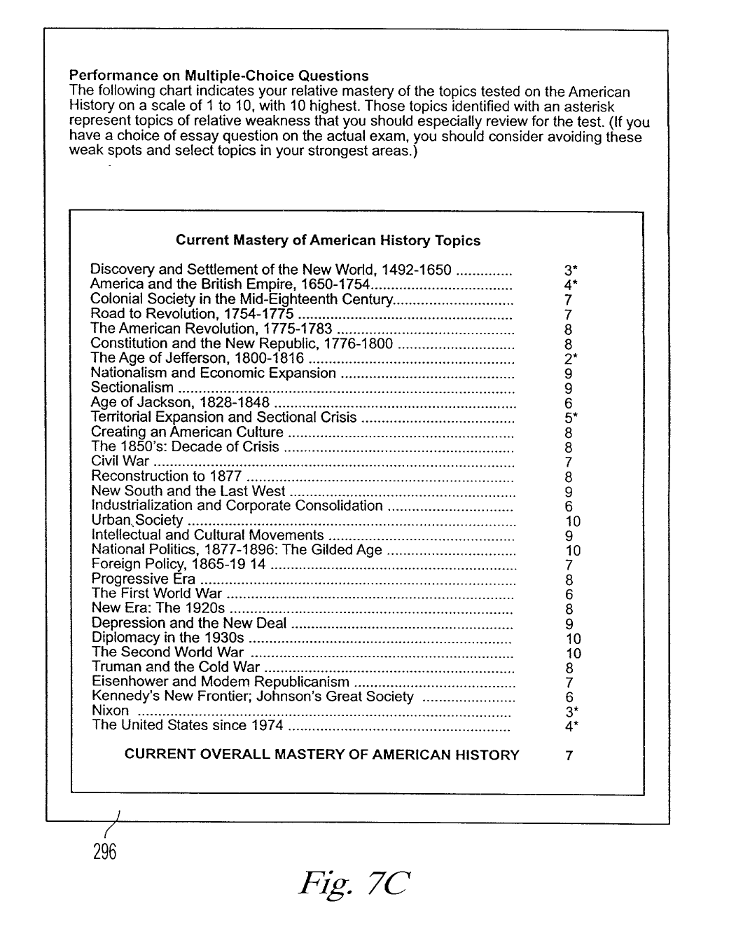

FIGS. 7a-7c show another sample display related to 916 of FIG. 2. In this sample, the essay grading system transmits an essay verbatim report display to the client computer. This display includes 6 sections: general information 291, overall essay score 292, verbatim list 293, submitted essay 294, resubmission 295, previous performance 296.

The sections of general information 291, overall essay score 292, and verbatim list 293 are shown in FIG. 7a. General information 291 includes the name of the user, the date of the submission of the essay, the subject of the essay, the essay question, and the outline topics related to the essay.

Overall essay score 292 recites the overall score and the subscores reported on the screen of FIG. 6. It also includes the user's numerical score.

Verbatim list 293 provides a verbatim list which, as discussed above, is a list of the ideal terms, with an indication whether each of these ideal terms is an omitted, or missed, term or an included term. In this list, the ideal terms are listed in declining importance.

The submitted essay section 294 and resubmission section 295 are shown in FIG. 7b. Submitted essay section 294 provides a verbatim display of the submitted essay for the user's review. Resubmission section 295 provides instructions on how to edit and resubmit the essay. The user can follow the instructions and edit and resubmit what the user submitted.

The previous performance section 296, shown in FIG. 7c, provides a list of scores on the user's performance on multiple-choice questions. It shows the topics on which the user's performance were poor and suggest that the user avoid these topics when actually taking an examination.

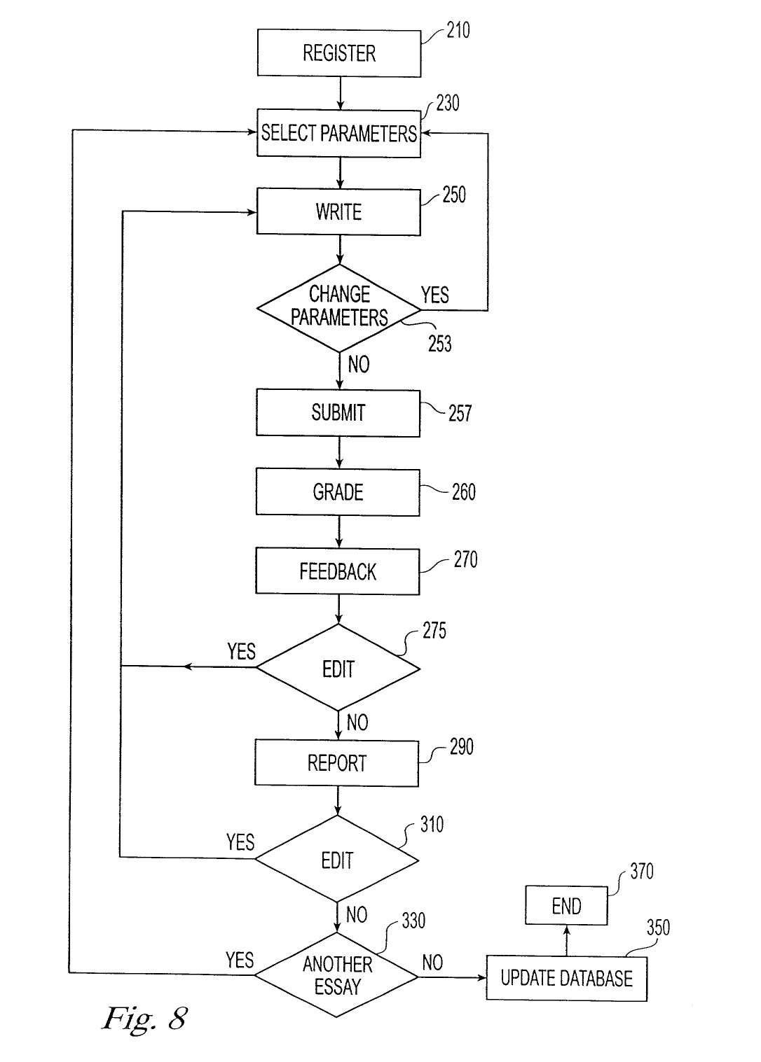

FIG. 8 is a flow chart showing a method of the essay grading system according to the present invention. At 210, a user accesses from a client computer a display page, such as a web page, transmitted from the essay grading system server to the client computer. The user logs on the essay grading system through the display page with a usemame and a password, as discussed earlier in FIG. 3. If it is the first time the user accesses the essay grading system or if the user does not have an established account in the essay grading system, the user may need to go through a registration process to establish an account with a usemame and a password. Upon successfully logging into the essay grading system, the user will be able to access a variety of information on the essay grading system. Some of the information may be related to an established account and may be pre-stored in association with the account. Such information can be automatically activated upon the submission of the username and password of the account.

At 230, the user chooses essay parameters provided by the essay grading system. When the user selects an appropriate button on the display page of the essay grading system indicating an essay session, the essay parameters are transmitted from the essay grading system server to the client computer. The essay parameters include a selection of the amount of time to spend, a selection of the grading policy, a selection of essay type, and a selection of essay topic, as discussed earlier in FIG. 4.

At 250, after the user completes the selection of essay parameters, an essay question associated with the selected essay topic is extracted from the essay grading system database and transmitted from the essay grading system server to the client computer. The user is also provided a window for inputting an essay in accordance with the essay parameters chosen.

Before submitting the essay, the user has the option of changing essay parameters, including the option of changing the topic of the essay, at 253. If the user decides to make the changes, the essay grading system loops back to 230. Otherwise, if the user decides not to change essay parameters, the user may continue writing until the essay grading system proceeds to 257.

At 257, the writing is submitted to the essay grading system for grading. This can be done in one of two ways. The first way is for the user to activate the “Rocketscore” submit button 258 button, once the user is done writing the essay. In this case, the essay is considered to be voluntarily submitted, since the user determines when to submit the essay. The second way is for the system to automatically submit whatever the user has entered on panel 259, whether or not the user is finished writing, upon expiration of the preset time period. As such, the essay in this second approach, may be considered to have been involuntarily, since the user takes no affirmative action. This is done by using the clock on the user's computer to keep track of elapsed time.

At 260, the essay grading system receives, stores, evaluates and grades the submitted essay. The essay grading system compares the submitted essay to a set of ideal terms associated with the same essay topic and identifies the omitted, or missed, terms and the included terms. Also, the essay grading system evaluates the submitted essay. The evaluation process includes weighting the ideal terms and calculating the subscores, as well as the overall score. This is all done in accordance with the expert information stored in the essay grading system.

At 270, the essay grading system sends feedback to the client computer. The feedback includes a list of the missed terms, an overall score in numerical representation, and subscores in numerical representations, as discussed earlier in FIG. 6. The list of missed terms constitutes an in-depth analysis of the submitted essay and serves as feedback from which the user can learn and improve the user's score.

During the review of the feedback, the user is given the option, at 275, of editing or rewriting the essay. If the user decides to edit or rewrite the essay, the essay grading system loops back to 250. If, on the other hand, the user decides not to edit or rewrite the essay, the user can continue reviewing the feedback.

At 290, the essay grading system transmits an essay verbatim report to the user at the client computer. As discussed earlier in FIG. 7a, the essay verbatim report includes a verbatim list, which contains both the included terms and the missed terms, so that the user knows for what terms credit was given, and also which terms should have been used.

Also transmitted from the essay grading system server to the client computer is a list of scores on the user's performance on a set of multiple-choice questions. This list shows the topics on which the user's performance was poor and provides a form of advice for the user to avoid these topics when actually taking an examination.

Also, during the review of the essay verbatim report, at 310, the user is given the option of revising the essay. If the user decides to revise the essay, the essay grading system loops back to 250. Otherwise, if the user decides not to revise the essay, the user can continue reviewing the essay verbatim report.

At 330, the user is given the option of writing another essay. If the user decides to write another essay, the essay grading system loops back to 230. Otherwise, if the user decides not to write another essay, the essay grading system proceeds to 350.

At 350, the essay grading system updates its database with the information generated in the essay session, including the date and time, the amount of time, the essay topic, the essay question, the submitted essay, the feedback, and the essay verbatim report. Thereafter, at 370, the essay grading system ends the essay session.

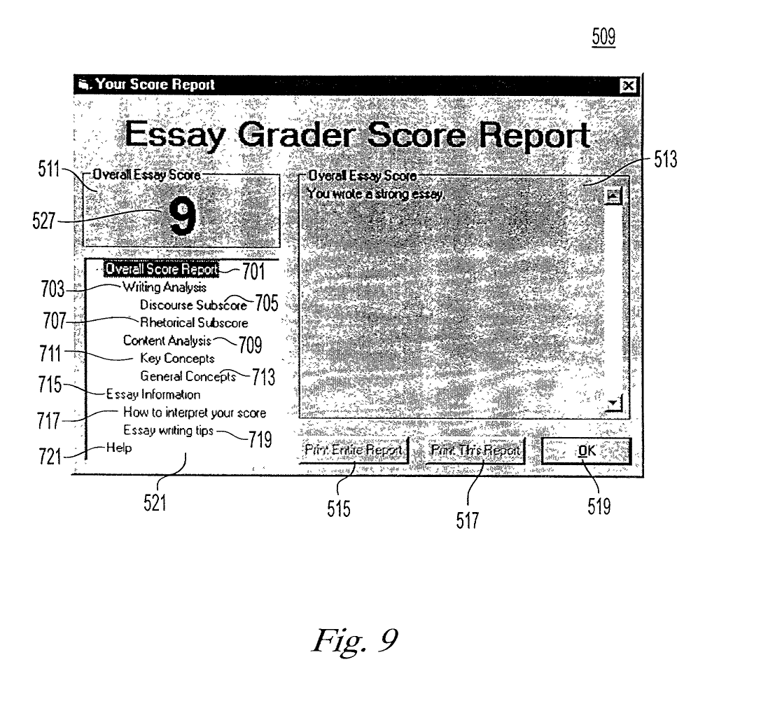

In another embodiment of the essay grading system, the score report takes the form of a pop-up panel 509 with more emphasis on the subscores. FIG. 9 shows a sample of the pop-up panel, entitled “essay grader score report”, which is transmitted to the user, upon the user's selecting “RocketScore” 258 in FIG. 5. As shown in FIG. 9, the pop-up “essay grader score report” panel 509 includes a score panel 511, a comments panel 513, a table of contents panel 521, a print entire report button 515, a print this report button 517, and an OK button 519.

The table of contents panel 521 lists the contents to be shown in this pop-up “essay grader score report” panel. In the sample pop-up “essay grader score report” panel 509 shown in FIG. 9, the table of contents panel 521 contains a list of first-level categories, including “overall score report” 701, “essay information” 715, and “help” 721. The first-level category “overall score report” 701 contains a list of second-level categories, including “writing analysis” 703 and “content analysis” 709. The second-level category “writing analysis” 703 further contains a list of third-level categories, including “discourse subscore” 705 and “rhetorical subscore” 707 and the second-level category “content analysis” 709 further contains a list of third-level categories, including “key concepts” 711 and “general concepts” 713. The first-level category “essay information” 715 contains a list of second-level categories, including “how to interpret your score” 717 and “essay writing tips” 719. When a user selects on a category in the table of contents panel 521, the selected category will be highlighted and the contents associated with this category will be shown in the appropriate parts of the pop-up “essay grader score report” panel, as discussed below.

The category “overall score report” 701 is associated with the display of the total score and the comments concerning the overall performance of the submitted essay. The category “writing analysis” 703 is associated with the display of the subscore and comments concerning the writing part of the submitted essay. The category “discourse subscore” 705 is associated with the display of the subscore and comments concerning the discoursing of the submitted essay. The category “rhetorical subscore” 707 is associated with the display of the subscore and comments concerning the rhetorical aspect of the submitted essay. The category “content analysis” 709 is associated with the display of the subscore and comments concerning the contents part of the submitted essay. The category “key concepts” 711 is associated with the display of the subscore and comments concerning the key concepts. The category “general concepts” 713 is associated with the display of the subscore and comments concerning the general concepts.

The category “essay information” 715 is associated with the display of the information concerning the essay writing on the essay grading system. The category “how to interpret your score” 717 is associated with the display of the information concerning the interpretation of the score and subscores on the essay grading system. The category “essay writing tips” 719 is associated with the display of tips on essay writing. In addition, the category “help” 721 is associated with the display of the technical information related to the essay writing on the essay grading system.

The score panel 511 shows, by default, the overall essay score 527 of a submitted essay, in correspondence with the first-level category “overall score report” 701 in the table of contents 521. It contains the title of “overall essay score” and a number (“9” in this instance) showing the overall essay score in numerical representation. The title and the number will not change if none of the second- or third-level categories under the first-level category “overall score report” 701 in the table of contents 521 is selected. However, when a second- or third-level category under the first-level category “overall score report” 701 in the table of contents 521 is selected, the title will change to that associated with the selected second- or third-level category. At the same time, the number will change to that associated with the numerical representation of the subscore associated with the selected second- or third-level category.

The comments panel 513 shows a title associated with the selected and therefore highlighted category in the table of contents 521. It also displays comments that are associated with, and change together with, the title. The print entire report button 515 allows a user to print the entire report, while the print this report button 517 permits the user to print the part of the report that is currently shown in the comments panel 513. The OK button 519, when activated, closes the pop-up “essay grader score report” panel.

In the screen shot shown in FIG. 9, the category “overall score report” 701 is selected and highlighted in the table of contents 521. Accordingly, in score panel 511, the title is “overall essay score” and the number “9” is the total score. Also, in comments panel 513, the title is “overall essay score” and the comment is “You wrote a strong essay”. All the displays in score panel 511 and comments panel 513 are associated with the category “overall essay score” selected and highlighted in the table of contents 521.

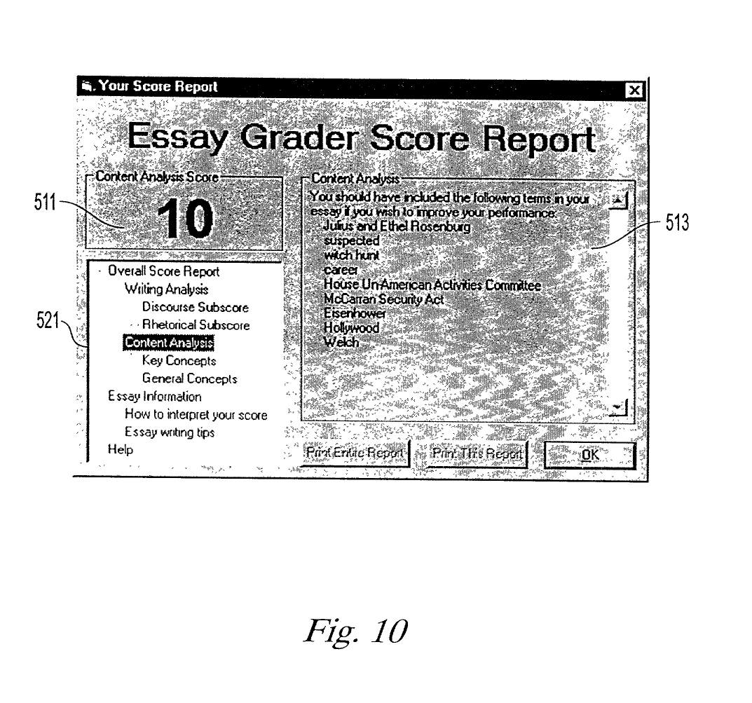

FIG. 10 shows another example of the display of the pop-up “essay grader score report” panel. In FIG. 10, the category “content analysis” is selected and highlighted in the table of contents 521. Accordingly, in score panel 511 , the title is “content analysis score” and the number “10” is the subscore of the content analysis aspect of the submitted essay. Also, comments panel 513 presents a list of missed terms. All the displays in score panel 511 and comments panel 513 are associated with the category “content analysis” selected and highlighted in the table of contents 521.

While the invention has been described and illustrated herein with respect to preferred embodiments, it should be apparent that various alternatives, modifications, adaptions, and variations will be apparent to those skilled in the art and may be made utilizing the teachings of the present disclosure without departing from the scope of the invention and are intended to be within the scope of the invention as defined by the claims herein.

What is claimed is:

1. A computer-assisted method of evaluating an essay, comprising:
receiving an essay concerning an essay topic;
electronically comparing textual content of the essay with a first number of terms related to said essay topic;
identifying missed terms, the missed terms being those terms which are among said first number of terms, but are not present in the textual content of the essay; and
transmitting the missed terms.

2. The method of claim 1, further comprising generating and transmitting at least one score concerning the essay.

3. The method of claim 2, further comprising generating and transmitting at least one subscore concerning an aspect of the essay.

4. The method of claim 1, wherein said receiving an essay comprises receiving the essay over the internet, and said transmitting the missed terms comprises sending the missed terms over the internet.

5. The method of claim 1, wherein said receiving an essay comprises receiving the essay from a first computer over a local area network, and said transmitting the missed terms comprises sending the missed terms over the local area network back to the first computer.

6. The method of claim 5, further comprising displaying the missed terms on the first computer.

7. The method of claim 5, wherein said comparing textual content is performed on a second computer connected to the local area network, the second computer being distinct from the first computer.

8. The method of claim 1, further comprising transmitting a selection of essay topics prior to receiving the essay, the selection of essay topics including said essay topic.

9. The method of claim 8, further comprising receiving information designating said essay topic, prior to comparing textual content.

10. The method of claim 1, further comprising identifying, and then transmitting, included terms among said first number, the included terms being those terms which are among said first number of terms, and are present in the textual content of the essay.

11. The method of claim 1, further comprising generating and transmitting at least one comment concerning the essay.

12. The method of claim 1, further comprising generating and transmitting at least one comment concerning an aspect of the essay.

13. A computer storage medium having executable software code, the executable software code including:
code to receive an essay concerning an essay topic;
code to electronically compare textual content of the essay with a first number of terms related to said essay topic;
code to identify missed terms, the missed terms being those terms which are among said first number of terms, but are not present in the textual content of the essay; and
code to transmit the missed terms.

14. The computer storage medium of claim 13, wherein the medium is selected from the group consisting of a hard disk, a floppy disk, and a CD-ROM.

15. The computer storage medium of claim 13, wherein the executable software code further includes code to identify and transmit included terms, the included terms being those terms which are among said first number of terms, and are present in the textual content of the essay.

16. The computer storage medium of claim 13, wherein the executable software code further includes code to generate and transmit a score concerning the essay.

17. The computer storage medium of claim 16, wherein the executable software code further includes code to generate and transmit a subscore concerning an aspect of the essay.

18. The computer storage medium of claim 13, wherein the executable software code further includes code to generate and transmit a first comment concerning the essay.

19. The computer storage medium of claim 18, wherein the executable software code further includes code to generate and transmit a second comment concerning an aspect of the essay.

20. The computer storage medium of claim 13, wherein the executable software code further includes code to transmit a selection of essay topics, the selection of essay topics including said essay topic.

21. The computer storage medium of claim 20, wherein the executable software code further includes code to receive information designating said essay topic.

22. A computer-assisted method of evaluating an essay on an essay topic, the method comprising:
providing a first essay on said essay topic, the first essay being a model essay;
extracting a first set of terms found in said model essay;
receiving a second essay on said essay topic;
searching for terms within said first set, in said second essay; and
transmitting those terms within said first set which are not present in said second essay.

23. The computer-assisted method of claim 22, further comprising transmitting those terms within said first set which are present in said second essay.

24. The computer-assisted method of claim 22, further comprising generating and transmitting a score concerning said second essay.

25. The computer-assisted method of claim 24, further comprising generating and transmitting a subscore concerning an aspect of said second essay.

26. The computer-assisted method of claim 22, further comprising receiving information designating said essay topic.

27. The computer-assisted method of claim 22, further comprising generating and transmitting a first comment concerning said second essay.

28. The computer-assisted method of claim 27, further comprising generating and transmitting a second comment concerning an aspect of said second essay.

29. A computer-assisted method of taking an essay examination comprising:
drafting an essay about an essay topic;
submitting the essay for evaluation by a computer; and
receiving a list of missed terms, the missed terms being those terms which are related to said essay topic but were not present in the essay that was drafted and submitted for evaluation.

30. The method of claim 29, further comprising receiving a list of included terms, the included terms being those terms which are related to said essay topic and are present in the essay that was drafted and submitted for evaluation.

31. The method of claim 29, further comprising receiving a score concerning said essay.

32. The method of claim 31, further comprising receiving a subscore concerning an aspect of said essay.

33. The method of claim 29, further comprising receiving a first comment concerning said essay.

34. The method of claim 33, further comprising receiving a second comment concerning an aspect of said essay.

35. The method of claim 29, further comprising:
receiving a list of possible essay topics; and
selecting one of said essay topics, prior to drafting the essay.

36. The method of claim 29, further comprising selecting a time period in which the essay is to be drafted.

37. The method of claim 29, wherein said drafting comprises revising an existing essay which previously was submitted for evaluation.

38. A computer system having associated therewith executable software code configured to grade an essay, the executable software code including:
code to receive an essay concerning an essay topic;
code to electronically compare textual content of the essay with a first number of terms related to said essay topic;
code to identify missed terms, the missed terms being those terms which are among said first number of terms, but are not present in the textual content of the essay; and
code to transmit the identified terms.

39. The computer system of claim 38, wherein the executable software code further includes code to identify and transmit terms among said first number which are present in the textual content of the essay.

40. The computer system of claim 38, wherein the executable software code further includes code to generate and transmit a score concerning the essay.

41. The computer system of claim 40 wherein the executable software code further includes code to generate and transmit a subscore concerning an aspect of the essay.

42. The computer system of claim 38, wherein the executable software code further includes code to generate and transmit a first comment concerning the essay.

43. The computer system of claim 42, wherein the executable software code further includes code to generate and transmit a second comment concerning an aspect of the essay.

44. The computer system of claim 38, wherein the executable software code further includes code to transmit a selection of essay topics, the selection of essay topics including said essay topic.

45. The computer system of claim 44, wherein the executable software code further includes code to receive information designating said essay topic.

46. A computer-assisted method of evaluating a document, the method comprising:
receiving a document from a computer;
electronically comparing textual content of the document with a predetermined list comprising a first number of terms;
identifying missed terms, the missed terms being those terms which are among said first number of terms, but are not present in said document; and
transmitting the missed terms to the computer.

47. A computer-assisted method of evaluating an essay, comprising:
transmitting a selection of essay topics;
receiving a selected essay topic, said selected essay topic being among said selection of essay topics;
selecting an essay question from a plurality of essay questions related to said selected essay topic;
transmitting said essay question;
receiving a first essay on said selected essay question;
extracting evaluation information associated with said selected essay question;
electronically comparing textual content of said first essay with a first set of terms previously extracted from a model essay;
identifying missed terms among said first set, the missed terms being those terms which are not present in the textual content of said first essay;
transmitting the missed terms;
generating a score concerning said first essay;
transmitting said score;
generating a subscore concerning an aspect of said first essay;
transmitting said subscore;
generating a first comment concerning said first essay;
transmitting said first comment;
generating a second comment concerning an aspect of said first essay;
transmitting said second comment;
identifying included terms among said first set, the included terms being those terms which are present in the textual content of said first essay; and
transmitting said included terms.

48. Computer storage medium having executable software code, the executable software code including:
code to transmit a selection of essay topics;
code to receive a selected essay topic, said selected essay topic being among said selection of essay topics;
code to select an essay question from a plurality of essay questions related to said selected essay topic;
code to transmit said selected essay question;
code to receive a first essay on said selected essay question;
code to extract evaluation information associated with said selected essay question;
code to electronically compare textual content of said first essay with a first set of terms previously extracted from a model essay;
code to identify missed terms among said first set, the missed terms being those terms which are not present in the textual content of said first essay;
code to transmit the missed terms;
code to generate a score concerning said first essay;
code to transmit said score;
code to generate a subscore concerning an aspect of said first essay;
code to transmit said subscore.
code to generate a first comment concerning said first essay;
code to transmit said first comment;
code to generate a second comment concerning an aspect of said first essay;
code to transmit said second comment;
code to identify included terms among said first set, the included terms being those terms which are present in the textual content of said first essay; and
code to transmit said included terms.

49. A computer system having associated therewith executable software code configured to grade an essay, the executable software code including:
code to transmit a selection of essay topics;
code to receive a selected essay topic, said selected essay topic being among said election of essay topics;
code to select an essay question from a plurality of essay questions related to said elected essay topic;
code to transmit said selected essay question;
code to receive a first essay on said selected essay question;
code to extract evaluation information associated with said selected essay question;
code to electronically compare textual content of said first essay with a first set of terms previously extracted from a model essay;
code to identify missed terms among said first set, the missed terms being those terms which are not present in the textual content of said first essay;
code to transmit the missed terms;
code to generate a score concerning said first essay;
code to transmit said score;
code to generate a subscore concerning an aspect of said first essay;
code to transmit said subscore.
code to generate a first comment concerning said first essay;
code to transmit said first comment;
code to generate a second comment concerning an aspect of said first essay;
code to transmit said second comment;
code to identify included terms among said first set, the included terms being those terms which are present in the textual content of said first essay; and
code to transmit said included terms.

50. A computer-assisted method of taking an essay examination comprising:
receiving a selection of essay topics;
selecting an essay topic, said selected essay topic being among said selection of essay topics;
transmitting said selected essay topic;
receiving an essay question related to said selected essay topic;
drafting an essay on said essay question;
submitting said essay;
receiving a list of missed terms, said missed terms being those terms which are related to said essay question but were not present in the essay that was drafted and submitted;
receiving a score, said score being associated with the evaluation of said essay;
receiving a subscore, said subscore being associated with the evaluation of an aspect of said essay;
receiving a first comment, said first comment being associated with the evaluation of said essay;
receiving a second comment, said second comment being associated with the evaluation of an aspect of said essay; and
receiving a list of included terms, said included terms being those terms which are related to said essay question and were present in the essay that was drafted and submitted.

51. The method of claim 50, wherein said drafting comprises revising an existing essay which previously was submitted for evaluation.
